(19) United States
(12) Patent Application Publication
(10) Pub. No.: US 2006/0139964 A1
(43) Pub. Date: Jun. 29, 2006

(54) Night light

(76) Inventors: Joseph DiOrio, North Providence, RI (US); James Richter, Bethpage, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/022,962

(22) Filed: Dec. 27, 2004

(51) Int. Cl. H01R 33/00

(52) U.S. Cl. 362/641

(57) ABSTRACT

Techniques and devices for a plug-in night light that is integrated into a wall plate include a night light coupled to a front surface of a wall plate. When the device is plugged into a receptacle outlet the wall plate covers the existing receptacle outlet cover to give the appearance of a permanently mounted lighting device. The night light may include a shade that can cause emitted light to emanate from across all or most of the front surface of the wall plate.

### BACKGROUND

1. Field

The present invention relates to a plug-in electrical device.

2. Description of the Related Art

A night light is a device that can provide light in an area that may be dimly lit or unlit. Night lights may be used in a bathroom or a kitchen. Other night lights may be used in hallways or parts of a room where receptacle outlets may be accessible to children. Night lights can be an afterthought that are added as needed. The night light may provide an insufficient amount of light from only a part of the receptacle. A Plug-in night light may be designed for easy removal to facilitate moving the night light between receptacle locations. As such, a night light may appear as a temporary device rather than a permanent lighting fixture because the night light may not be secured in a particular location.

A night light may have electrically conductive blades that are plugged into a receptacle outlet. The blades can carry electrical current from the receptacle outlet to the night light. Minor dislocations of the night light can expose the electrically conductive blades. The blades also may be exposed as the night light is unplugged resulting in a hazardous shock condition. A night light can be located in a receptacle near the floor where it is accessible to children. The night light can be removed easily from a receptacle for the convenience of a user in plugging and unplugging the blades. Because the night light may be made easy to unplug, it may increase the safety hazard of exposed electrically conductive blades. Young children and infants may be attracted to the night light, particularly when accessible at eye level near the floor. Moreover, night lights are generally larger than normal plugs, thus providing a large gripping surface for crawling infants and children. It is, therefore, possible for infants and children to partially remove the night light from the outlet and insert their small fingers into contact with the live power blades significantly increasing the possibility of being electrocuted.

### SUMMARY OF THE DISCLOSURE

A plug-in electrical device includes a wall plate having a front surface, a back surface and peripheral edges. The electrical plug-in device can be integral with the front surface of the wall plate. An area covered by the wall plate may be larger than the area of a receptacle outlet cover. Conductive blades of the electrical device can protrude through the back surface of the wall plate such that when the conductive blades are inserted into a receptacle outlet having a receptacle outlet cover, the wall plate peripheral edges cover a front and sides of the receptacle outlet cover.

In an implementation, the wall plate peripheral edges are substantially in contact with a mounting surface, such as a wall, of the receptacle outlet when the blades are inserted into the receptacle outlet.

Some of the implementations of the disclosures may include one or more of the following advantages. The night light can provide the appearance of a permanently mounted lighting device while providing the flexibility of a plug-in device that may be relocated as desired. A wall plate of the lighting device can provide safety from a potential shock hazard by making it difficult to expose the blades of the electrical device while the blades are electrically connected to a receptacle outlet. The electrical device integral with a wall plate may include more than one electrical device and/or night light. Thus, multiple electrical devices may be integrated with the wall plate to provide multiple electrical functions.

### BRIEF DESCRIPTION OF THE DRAWINGS

FIG. 1 is a front perspective of a night light in accordance with the present techniques.

FIG. 2 is a rear perspective view of the night light of FIG. 1.

FIG. 3 is a side view of the night light of FIG. 1.

FIG. 4 illustrates a night light in accordance with the present invention installed in a receptacle outlet. An example of a standard receptacle outlet is shown for comparison.

FIG. 5 is a front view of a night light of the present invention that uses one receptacle outlet of a duplex receptacle uncovered.

For purposes of brevity and clarity, like elements will have the same numerical designation throughout the figures.

### DETAILED DESCRIPTION

This disclosure provides techniques and devices for a plug-in night light that is integral with a wall plate. When the night light is plugged into a receptacle outlet the wall plate covers the existing receptacle outlet cover to give the appearance of a permanently mounted lighting device.

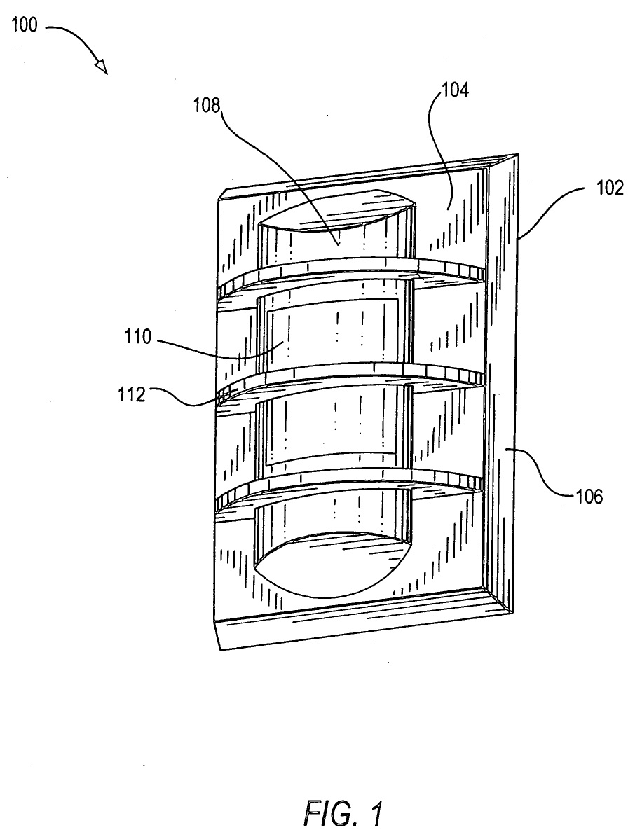

FIG. 1 illustrates a perspective view of a front surface of an implementation of a plug-in electrical device 100 in accordance with the present disclosure. The device includes a wall plate 102 that may be oblong shaped. The wall plate can have beveled edges 106 to simulate the look of a standard outlet cover and have a front surface 104. An electrical device 108 (e.g., a night light) may be mounted on or attached to the front surface 104 of the wall plate 102 such that the electrical device and the wall plate appear to be one piece. The electrical device 108 may be, for example, one or more of the following: a night light, a light sensor, an electrically operated air freshening device and/or a premises protection device such as a motion detector. A cover or shade 110 can protect the electrical device 108 or shade the device when it is a night light, for example. The shade 110 can include a diffuser to spread emitted light evenly or to scatter emitted light and may be opaque, translucent or transparent either partially, entirely or in combination. The shade can cause light from a lamp of a night light to emanate from across all or most of the front surface of the wall plate. The night light may have additional features 112 that can couple the electrical device 108 to the front surface 104 or may be ornamental.

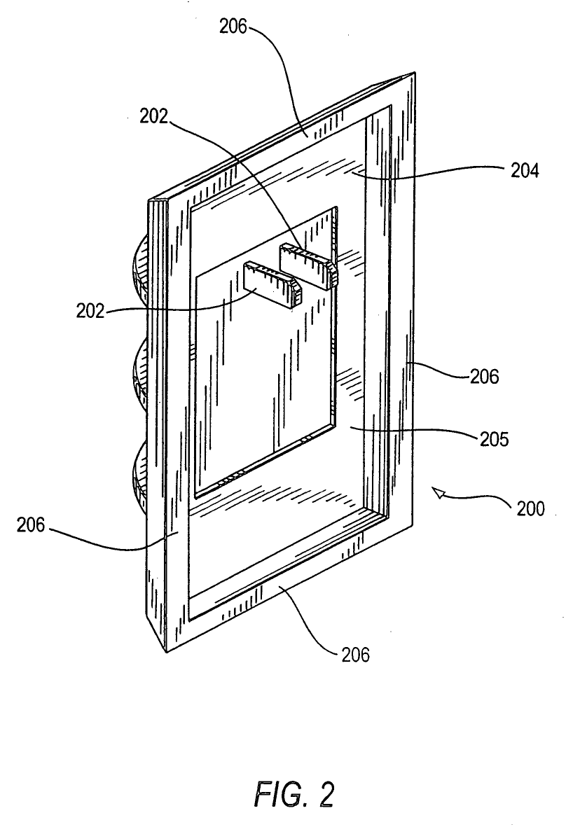

FIG. 2 illustrates a perspective view of a back surface 200 of the plug-in electrical device of FIG. 1. The back surface includes a recessed portion 204 and surrounding peripheral edges 206. The peripheral edges 206 may define an opening 205 of the recessed portion that can be sized larger in both length and width than the standard outlet cover. The recessed portion 204 can be recessed from the peripheral edges a depth that is deeper than the depth of the standard outlet cover. Electrically conductive blades 202 of the electrical device (e.g., night light) protrude through the back surface a distance sufficient to provide proper contact between the blades and a receptacle outlet when the night light is plugged into the receptacle outlet.

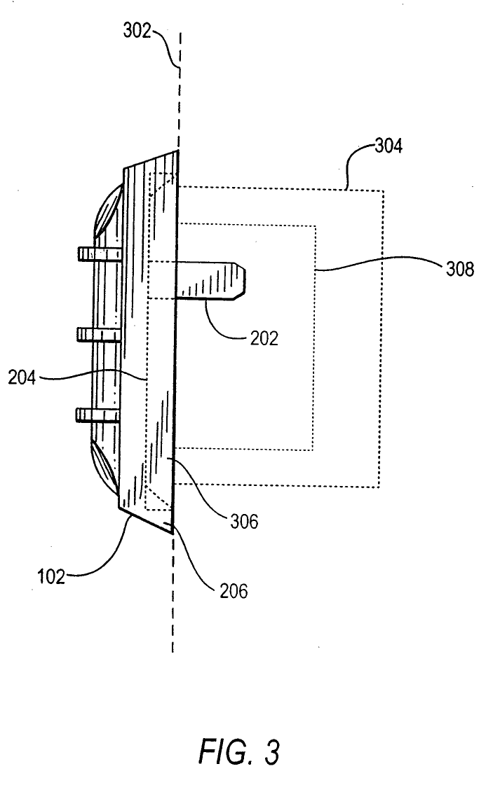

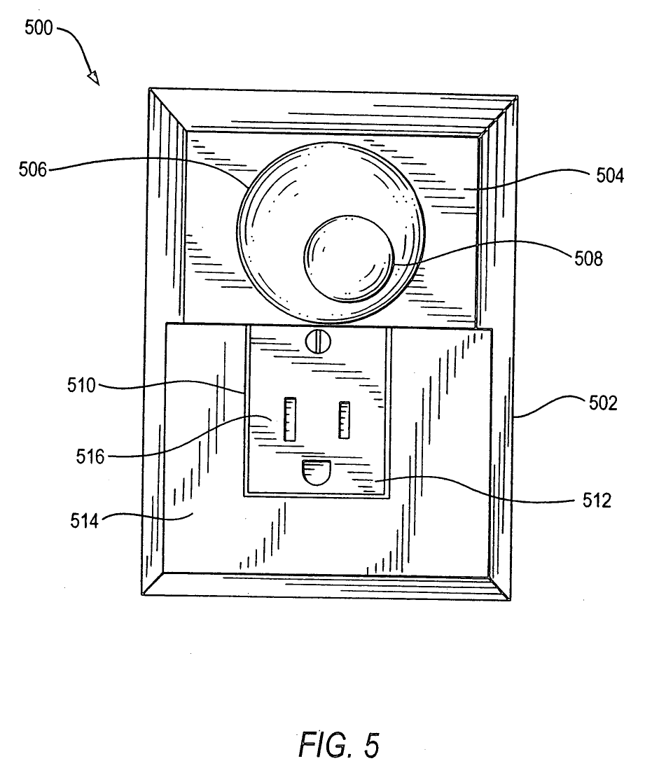

FIG. 3 is a side view of an implementation of a night light plugged-in to a duplex receptacle outlet 308 mounted in a receptacle outlet box 304, which are shown in dashed lines and are not part of the invention. The receptacle outlet box 304 may be mounted on a wall 302 (also shown in dashed lines) and have a receptacle outlet cover 306. The receptacle outlet 308 includes two openings (not shown) into which blades 202 may be frictionally inserted. When the conductive prongs 202 are plugged into the receptacle outlet 308 openings, the back surface recessed portion 204 of the wall plate can fit over the front and sides of the receptacle outlet cover 306 and the wall plate peripheral edges 206 may be in substantial contact with the wall 302. The wall plate 102 also may be fastened to the receptacle outlet cover and/or receptacle outlet box with a screw, clip, magnet, or other mechanical means (not shown). The wall plate 102 can shield both halves of the receptacle and may be difficult to manipulate to expose the conductive blades while electrically connected to the receptacle outlet. The wall plate 102 also may provide for access to a second receptacle outlet of a duplex outlet. See, for example, FIG. 5. In this case, the wall plate 102 can be arranged to keep the conductive blades from exposure while electrically connected to a first receptacle outlet of the duplex receptacle.

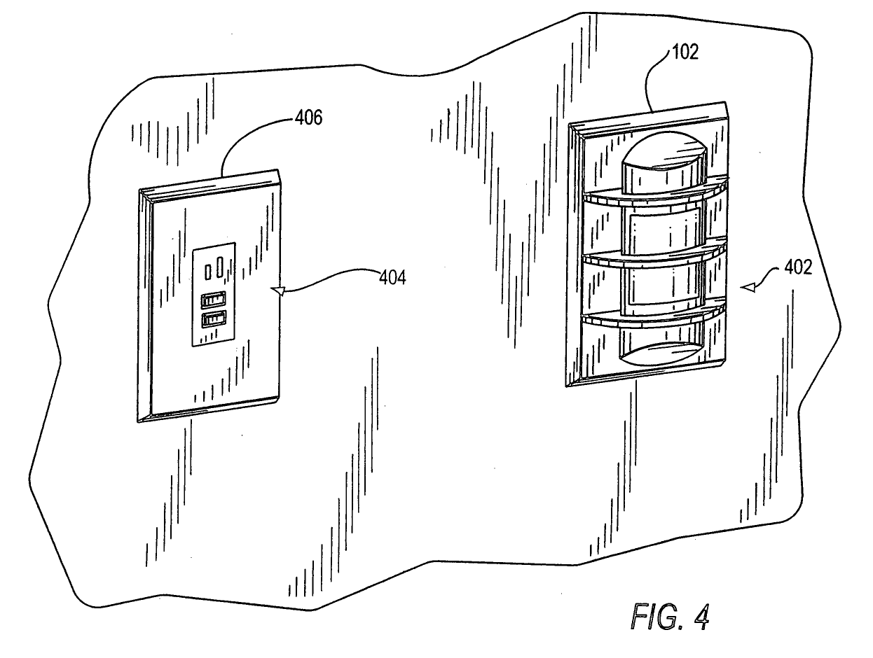

FIG. 4 illustrates a view of an implementation of the disclosed night light 402 installed in a receptacle outlet (not shown) mounted to a wall. The wall plate 102 covers the receptacle outlet and receptacle outlet cover on the front and sides. An example of a standard receptacle outlet 404 is shown for comparison. The wall plate 102 is larger than a standard receptacle outlet cover 406. The night light 402 can give the appearance of a permanently mounted lighting fixture even though the night light may be unplugged and relocated as desired.

FIG. 5 illustrates an alternative implementation of the disclosed night light assembly 500 wherein part of a duplex receptacle outlet 512 remains exposed. The night light assembly includes a night light 506 integral with a wall plate 502. The wall plate 502 can have an upper portion 504 that covers a first receptacle outlet (not shown) of the duplex receptacle 512. The upper portion 504 can include a “ball-shaped” night light 506 rotatable in a mounting socket (not shown), for example. The night light 506 may have an illuminating area 508 which may be directed by a user to illuminate a desired area by rotation of the ball-shaped night light. A lower portion 514 of the wall plate can have an opening 510 therein to expose a second receptacle outlet 516 of the duplex receptacle outlet. As described above, the wall plate 502 covers the receptacle outlet cover of the duplex receptacle outlet.

While there have been shown and described and pointed out the fundamental features of the invention as applied to the preferred embodiment, as is presently contemplated for carrying them out, it will be understood that various omissions and substitutions and changes of the form and details of the device described and illustrated and in its operation may be made by those skilled in the art, without departing from the spirit of the invention. As such, other embodiments are within the scope of the following claims.

What is claimed is:

1. A device comprising:
a wall plate;
an electrical device attached to the wall plate,
wherein, when the electrical device is coupled to a receptacle outlet having a receptacle outlet cover, the wall plate covers a front and sides of the receptacle outlet cover.

2. The device of claim 1, wherein the electrical device is coupled to the receptacle outlet by electrically conductive blades.

3. The device of claim 1, wherein the electrical device comprises a night light.

4. The device of claim 3, wherein the wall plate covers at least a portion of a receptacle outlet cover associated with the receptacle outlet.

5. A plug-in electrical device, comprising:
a wall plate having a front surface, a back surface and peripheral edges; and
an electric device coupled to the front surface of the wall plate and having conductive blades protruding through the back surface,
wherein, when the conductive blades are inserted into a receptacle outlet having a receptacle outlet cover, the wall plate front surface and peripheral edges cover a front and sides of the receptacle outlet cover.

6. The plug-in device of claim 5, wherein the wall plate peripheral edges are substantially in contact with a mounting surface of the receptacle outlet.

7. The plug-in device of claim 5, wherein the electrical device comprises a night light.

8. The plug-in device of claim 7 comprising a light diffuser coupled to the wall plate and covering the night light.

9. The plug-in device of claim 5, wherein the electrical device comprises an air-freshener.

10. The plug-in device of claim 5, wherein the wall plate has an oblong shape similar to the receptacle outlet cover and completely covers the receptacle outlet cover.

11. The plug-in device of claim 5, wherein the wall plate has an oblong shape similar to the receptacle outlet cover and completely covers the receptacle outlet cover.

12. The plug-in device of claim 5 wherein the wall plate has an oblong shape similar to the receptacle outlet cover and covers one receptacle outlet having an opening to provide access to a second receptacle outlet of a duplex receptacle outlet.

13. A method comprising:
providing a wall plate; and
attaching an electrical device to the wall plate,
wherein when the electrical device is coupled to a receptacle outlet, the wall plate covers at least a portion of the receptacle outlet.

14. The method of claim 13, wherein the electrical device is coupled to the receptacle outlet by electrically conductive blades.

15. The method of claim 13, wherein the electrical device comprises a night light.

16. The method of claim 15, wherein the wall plate covers at least a portion of a receptacle outlet cover associated with the receptacle outlet.

17. A method comprising:
providing a wall plate having a front surface, a back surface and peripheral edges; and
coupling an electrical device to the front surface of the wall plate, conductive blades of the electrical device protruding through the back surface,
wherein, when the conductive blades are inserted into an receptacle outlet having a receptacle outlet cover, the wall plate covers a front and sides of the receptacle outlet cover.

18. The method of claim 17, wherein the wall plate peripheral edges are substantially in contact with a mounting surface of the receptacle outlet.
